(19) United States
(12) Patent Application Publication
(10) Pub. No.: US 2015/0044012 A1
(43) Pub. Date: Feb. 12, 2015

(54) ROTATING SHIPPING AND STORAGE CONTAINER

(71) Applicant: Paul Christopher Pitts, Dauphin Island, AL (US)

(72) Inventor: Paul Christopher Pitts, Dauphin Island, AL (US)

(73) Assignee: Commodity Shipping Solutions, LLC, Dauphin Island, AL (US)

(21) Appl. No.: 14/084,332

(22) Filed: Nov. 19, 2013

Related U.S. Application Data
(60) Provisional application No. 61/862,965, filed on Aug. 7, 2013.

(51) Int. Cl. B65D 88/12; B65G 65/00; B65D 88/02

(52) U.S. Cl. CPC B65D 88/128; B65D 88/02; B65G 65/00
USPC 414/800; 220/1.5; 220/651

(57) ABSTRACT

The invention discloses a rotating container and method of shipping, transporting, and using the container. The container has utility for transport, onsite storage, shipping, intermodal shipping, and commodity loading and unloading. An embodiment of a version of the invention comprises an exoskeleton, a tank positioned inside the exoskeleton, a rotator between the tank and exoskeleton, and the tank and exoskeleton attached to the rotator.

### CROSS REFERENCES

This application claims the benefit of U.S. Provisional Application No. 61/862,965, filed on Aug. 7, 2013, which application is incorporated herein by reference.

### FIELD OF THE INVENTION

A preferred embodiment of the invention refers to a rotating shipping and/or container and method of use.

### BACKGROUND

Storing and transporting goods is essential to modern life. However, current methods leave much to be desired. Various types of containers and storage methods are used at different points in the process of packaging, unloading, and storing commodities. This process takes significant time, puts the commodities at risk of contamination at each transfer point, decreases overall yield, and decreases profitability and productivity due to lost time and goods.

Many goods are shipped from all over the world to end users in locations far removed from the goods' origin point. A large amount of shipped goods travel intermodally on standardized shipping containers. Furthermore, intermodal containers (also known as freight containers, ISO containers, and shipping containers) are no longer just an international phenomenon. Intermodal containers now transport many domestic cargoes. Overall, the current methods used to ship commodities have remained the same for many years. Furthermore, the shipping and storing methods used in shipping containers, silos, and other storage and shipping containers has also remained much the same.

The basic types of intermodal containers are flat racks, open-top, insulated, reefer, and tank containers. Open-top containers and dry-freight containers (also known as cube containers) are most often used for shipping dry goods. Open-top containers are shaped like a box and loaded from either the top or end. They are designed to carry heavy, tall, or hard to load materials such as coal or grain. Dry freight containers (or cube containers) are front loaded, completely enclosed, and suitable for general-purpose transportation.

Tank containers are built to the same standard dimensions as other ISO containers, but are made up of vessels mounted inside of a rectangular steel framework (also known as an exoskeleton). Generally, these containers have been used to transport liquid or bulk materials. Presently, tank containers are rarely, utilized for shipping and storing dry commodities.

After the goods are transported to the offload location, the commodity unloading process takes place. When the commodities are offloaded from the shipping container, the bulk commodity may remain in a pit, or may be loaded into some other storage tank, such as a silo or bin. If remaining in an open pit until needed, the commodity is exposed to wind, rain, and other elements, thus contaminating the product. If the bulk commodity is loaded into a storage bin or tank, a great deal of time and effort must again be expended to load the material into the final storage container. Additionally, the process of loading bulk material into silos and other storage tanks requires large, heavy, and expensive equipment. Furthermore, the process of loading and subsequently unloading a silo or storage tank is dangerous.

For example, filling a silo requires two tractors very close to each other, both running at full power and with live rotating shafts providing the energy. One of the tractors powers the silo blower and the other powers a forage wagon for unloading material into the blower. During the filling process, a worker must continually move around in this highly hazardous environment of spinning shafts and high-speed conveyors to check material flows, adjust speeds, and to start and stop the equipment between loads.

In addition to the actual loading, the preparation for loading a silo is very dangerous. This job requires material at the bottom of the silo to be manually removed. Thus, a worker must enter the silo and work directly below a machine weighing several tons suspended fifty feet or more overhead from a small steel cable. If the unloader were to fall, the worker would be killed instantly.

The process of unloading a silo or other storage tank is also dangerous. For one, a worker must regularly climb the silo to close or open the doors, and move the unloader chute from one door to another in the process. Since fermentation takes place in many silos, the displacement of oxygen can cause a worker in a silo to be asphyxiated by the methane, knocked unconscious, and silently suffocate to death. If the unloader mechanism becomes clogged or plugged, the worker must climb the silo and directly stand on the unloader, reaching into the blower spout to dig out the soft silage.

As noted from the foregoing, problems exist in the fields relating to commodity shipping and storage based primarily on current shipping and storage methods. Therefore, a need exists in the art for a shipping container that also functions as a storage container. Additionally, a need exists in the art for a tank container capable of storing dry bulk commodities. Additionally, a need exists in the art for a tank container having a rotator.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A preferred embodiment of a version of the invention is directed to a container. In one embodiment, the container comprises an exoskeleton, a tank positioned inside the exoskeleton, a rotator between the tank and exoskeleton, and the tank and exoskeleton attached to the rotator.

It is one purpose of an embodiment of the present invention to utilize tank containers for dry bulk commodity shipping. It is yet another purpose of an embodiment of the present invention to utilize a rigid exoskeleton, as in a tank container, to house a rotating container therein. It is yet another purpose of an embodiment of the invention to provide a shipping and storage container in one.

### DESCRIPTION OF THE DRAWINGS

These and other features, aspects, and advantages of the present invention will become better understood with regard to the following description, appended claims, and accompanying drawings where:

FIG. 1 is a perspective view of an apparatus embodying features of the present invention for a rotating shipping and/or storage container in an offload position.

FIG. 2 is a front side view of an apparatus embodying features of the present invention for a rotating shipping and/or storage container.

FIG. 3 is a back side view of an apparatus embodying features of the present invention for a rotating shipping and/or storage container.

FIG. 4 is a left side view of an apparatus embodying features of the present invention for a rotating shipping and/or storage container.

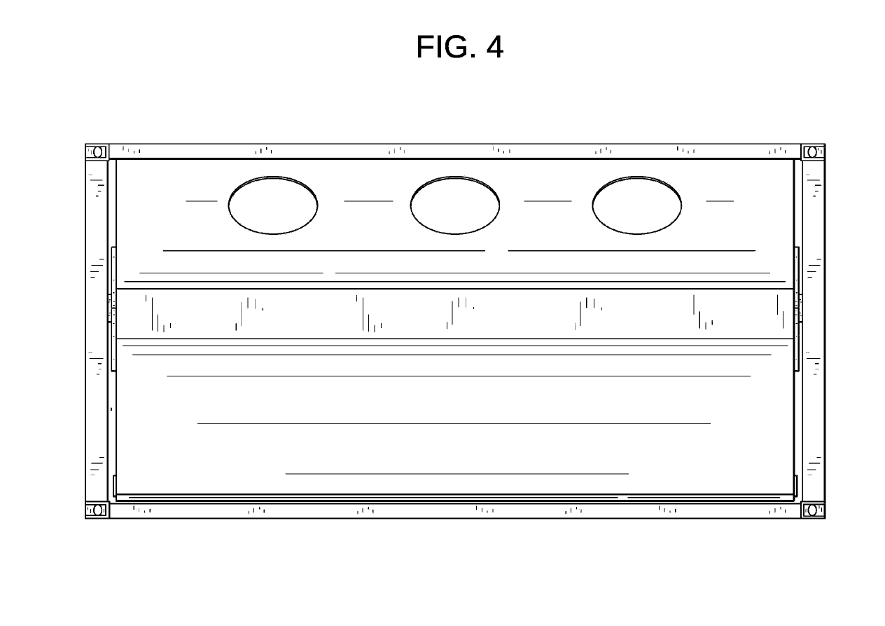

FIG. 5 is a right side view of an apparatus embodying features of the present invention for a rotating shipping and/or storage container.

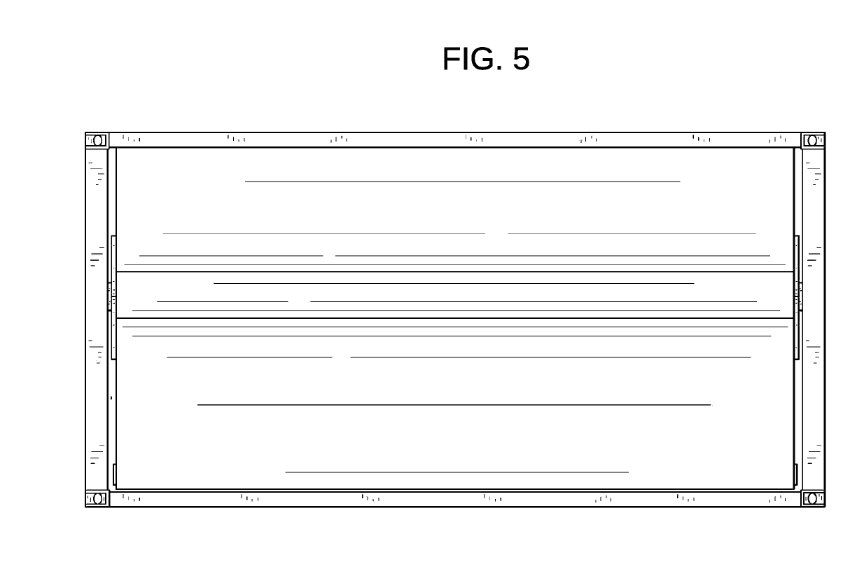

FIG. 6 is a top side view of an apparatus embodying features of the present invention for a rotating shipping and/or storage container.

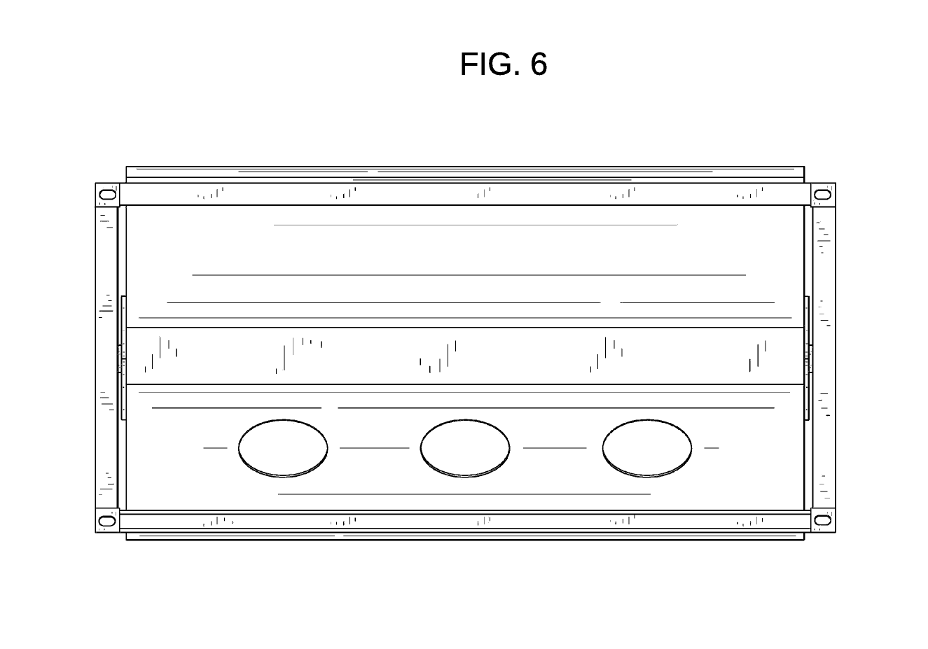

FIG. 7 is a bottom side view of an apparatus embodying features of the present invention for a rotating shipping and/or storage container.

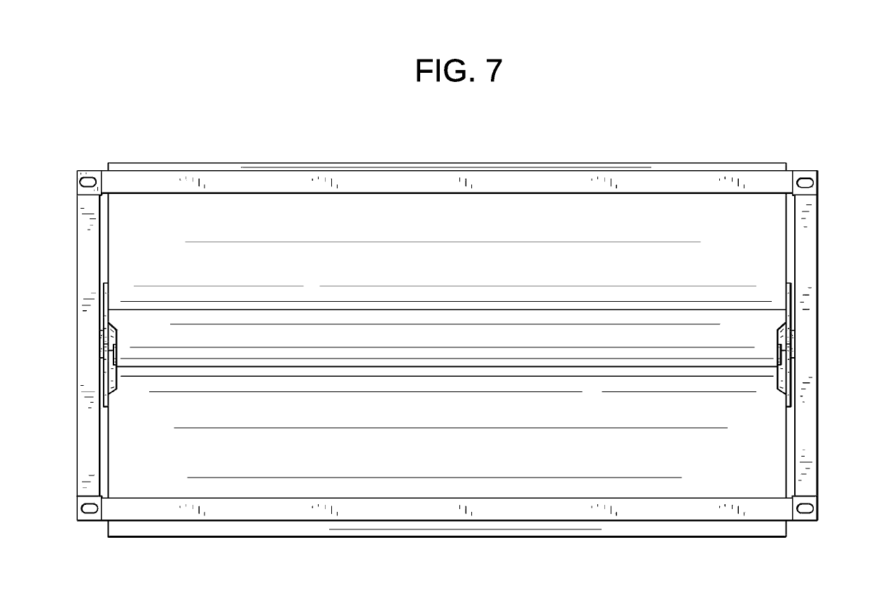

FIG. 8 is a perspective view of an apparatus embodying features of the present invention for a rotating shipping and/or storage container in a transport position.

FIG. 9 is a perspective view of an apparatus embodying features of the present invention for a rotating shipping and/or storage container structure.

FIG. 10 is a perspective view of an offload system found in a version of the present invention for a rotating shipping and/or storage container.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components, or can contain at least one component chosen from A, B, or C.

Where reference is made herein to a method comprising two ore more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

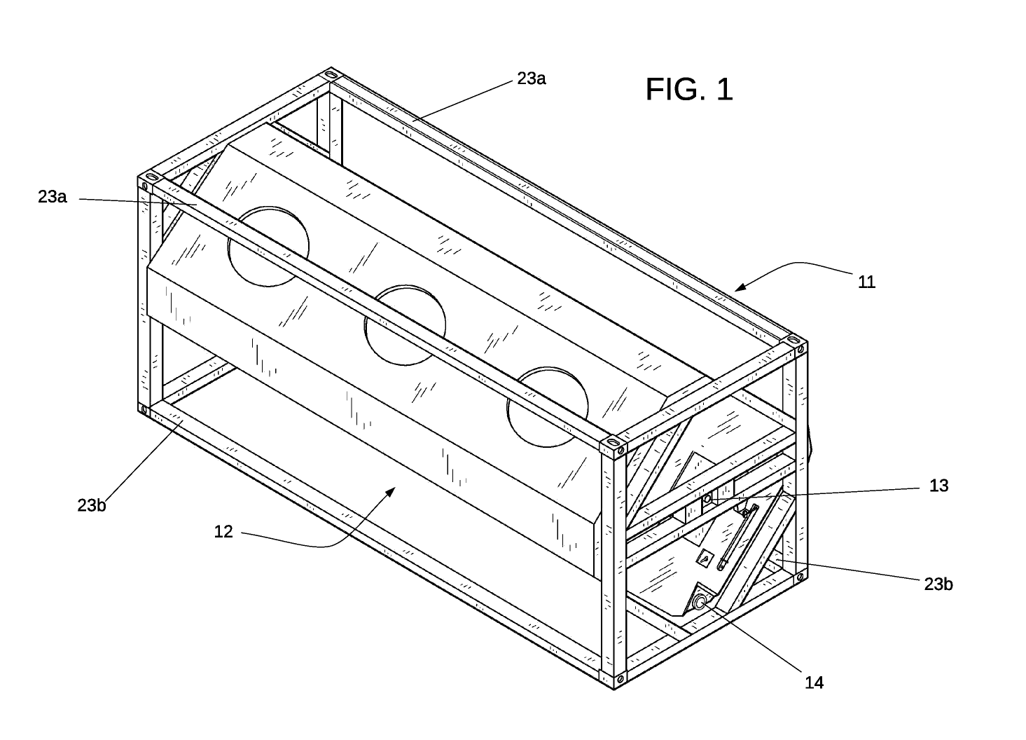

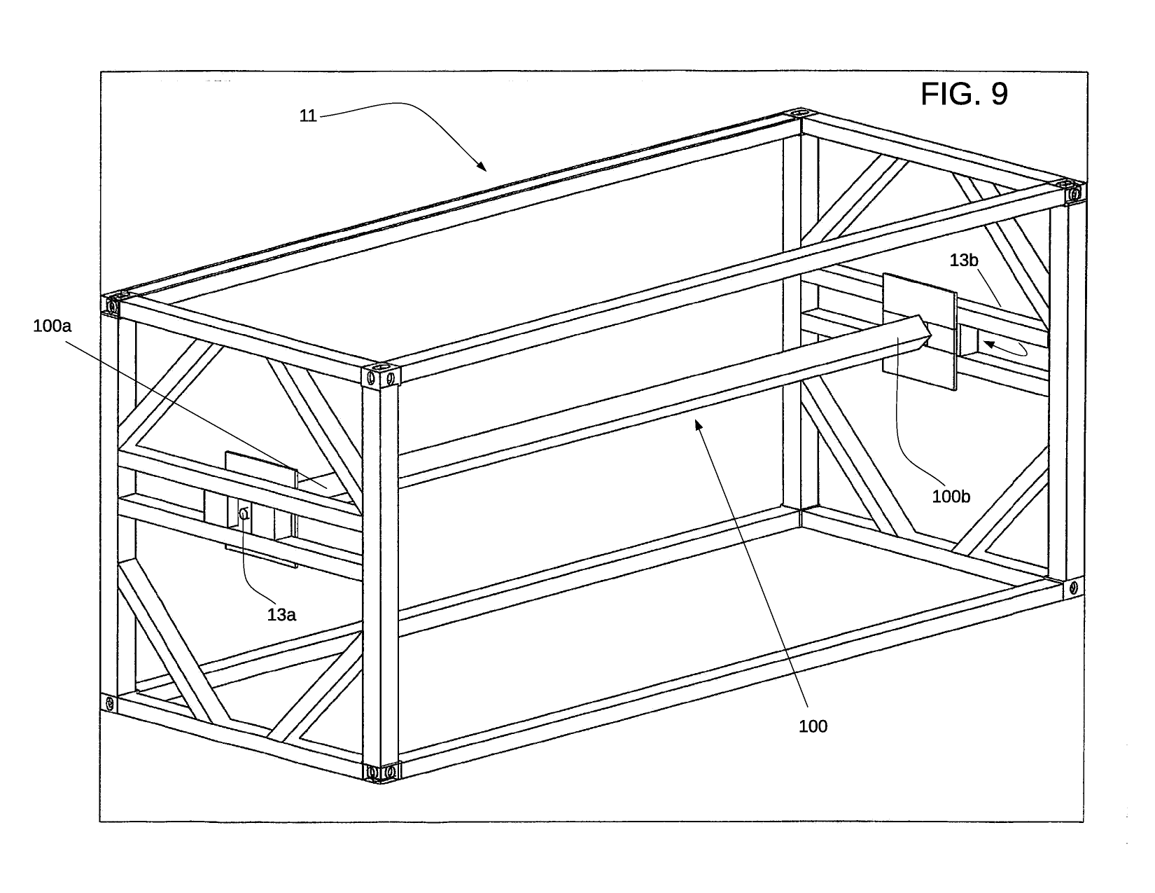

As illustrated in FIG. 1, a preferred embodiment of a version of the invention is directed to a container 10. In one embodiment, the container 10 comprises an exoskeleton 11, a tank 12 positioned inside the exoskeleton, a rotator 13 between the tank 12 and exoskeleton 11, and the tank 12 and exoskeleton 11 attached to the rotator 13. As shown in FIG. 9, in a preferred embodiment, the tank 12 is connected to the rotator 13 and exoskeleton 11 by a structural rod 100.

One embodiment of the present invention comprises the container 10 being a shipping container. Versions of the invention allow for various uses including, but not limited to, the shipping container being permanently fixed to a truck, train, or other transport vehicle. Another version of the invention comprises the shipping container being portable. A preferred version of the invention is the shipping container being an intermodal shipping container (also known as a freight container or ISO container). It is understood that versions of the invention may be embodied in different shapes or dimensions.

Yet another version of the invention comprises the container being fully sealable and capable of maintaining low pressure by applying vacuum.

Yet another embodiment of the present invention comprises the container 10 being for onsite storage.

Another embodiment of the present invention comprises the container 10 being an intermodal container.

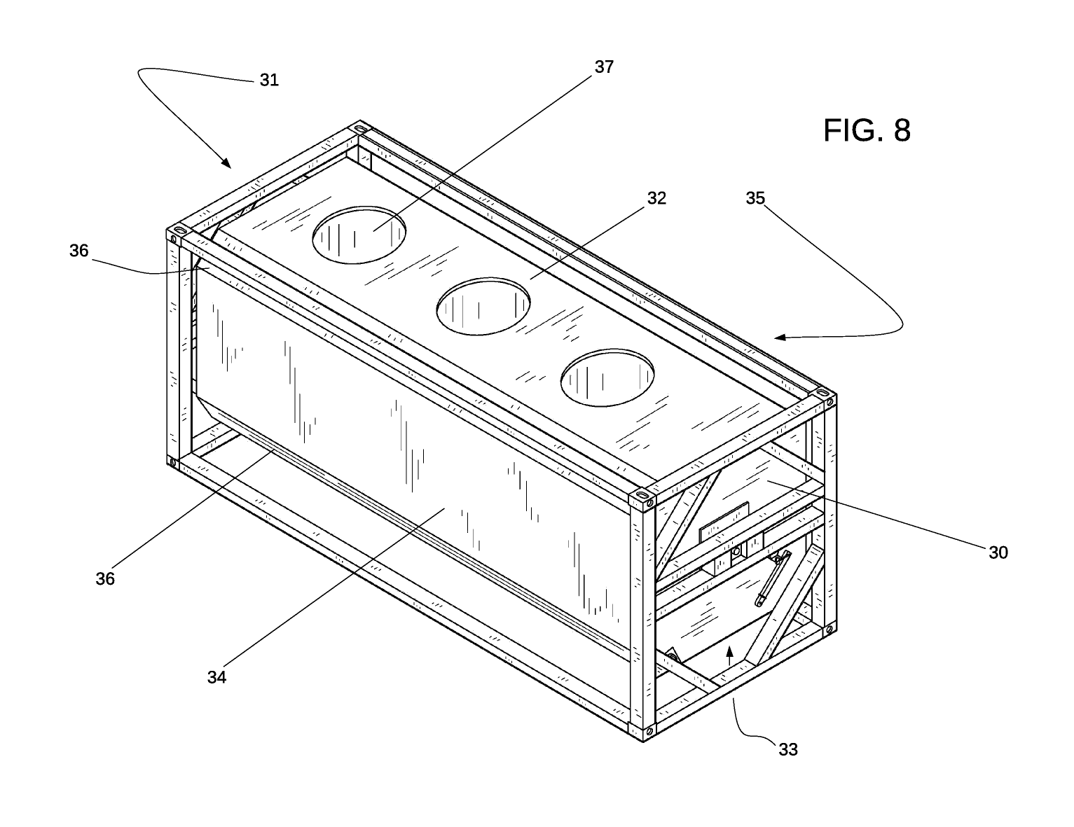

As illustrated in FIG. 8, an embodiment of a container of the present invention comprises the tank 12 inside the exoskeleton 11 having an upper 32 and lower 33 portion. The upper portion 32 of the tank has a receiver 37 capable of receiving material into the tank. Different versions of the invention have different receivers. In one embodiment, the receiver is a door-like mechanism capable of being latched. In a preferred embodiment, the receiver is sealed. One version of the invention comprises a locking mechanism on the receiver. The invention includes at least one receiver. It is understood that a version of the invention includes all types of receivers.

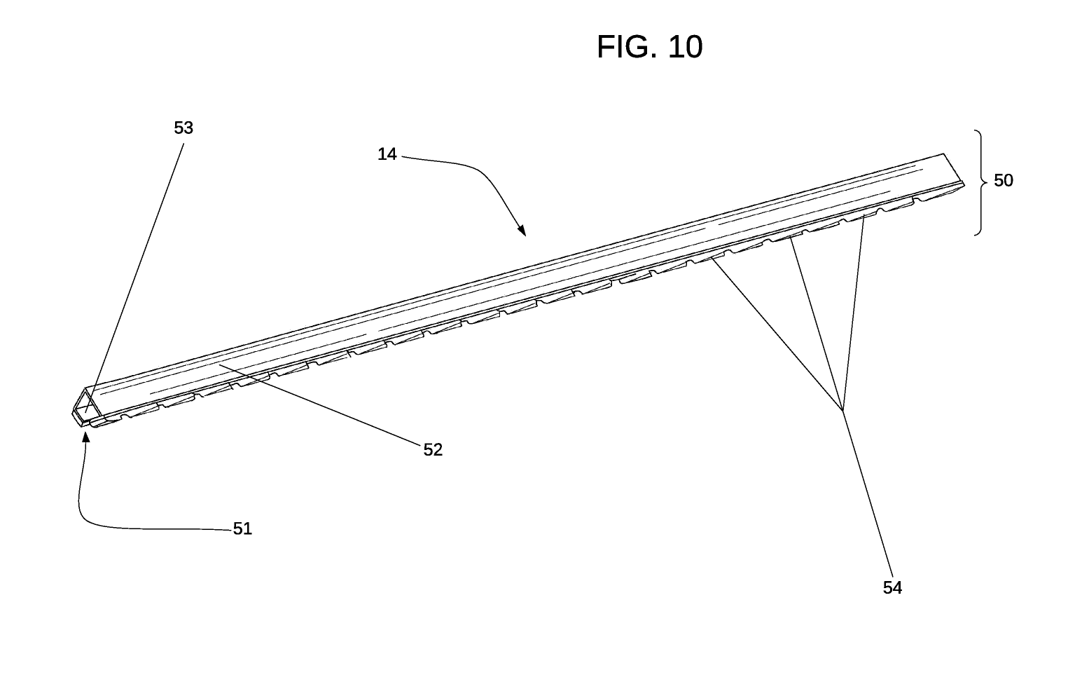

The lower portion 33 of the tank has an offload channel 14 capable of unloading material from the tank. As illustrated in FIG. 10, a preferred embodiment of a version of the offload system comprises a container offload system 14 comprising a longitudinal body 50 in the shape of a diamond with an open bottom 51 for commodities to pass. In one embodiment, the diamond shaped longitudinal body 50 has an open bottom 51 forming a channel therein. The commodities pass through the open bottom 50 into a channel. The longitudinal body 50 has an upper 52 and lower 53 section. The upper section 52 forms the upper portion of the longitudinal body 50 diamond shape.

An embodiment of a version of the invention further comprises the lower section 53 of the longitudinal body having spacers 54 attached thereto. The spacers 54 are attached to both sides of the lower section 53 of the longitudinal body 50. The spacers 54 are attached to the exterior sides of the longitudinal body lower section 53 so as to be in contact with the commodity. In one embodiment, the spacers are triangles.

In a preferred embodiment of a version of the invention, the spacers 54 are triangles having a flat bottom and a pointed top. The flat bottom is located near the open space 51 at the bottom of the longitudinal body lower section 53. The triangle top point is located farthest away from the open space 51 at the bottom of the longitudinal body lower section 53.

An embodiment of a version of the invention further comprising, the spacers 54 are staggered on each side of the longitudinal body lower section 53 such that the middle of the bottom section of a spacer 54 on one side of the longitudinal body lower section 53 is opposite the space between two spacers 54 on the opposite side of the longitudinal body lower section 53.

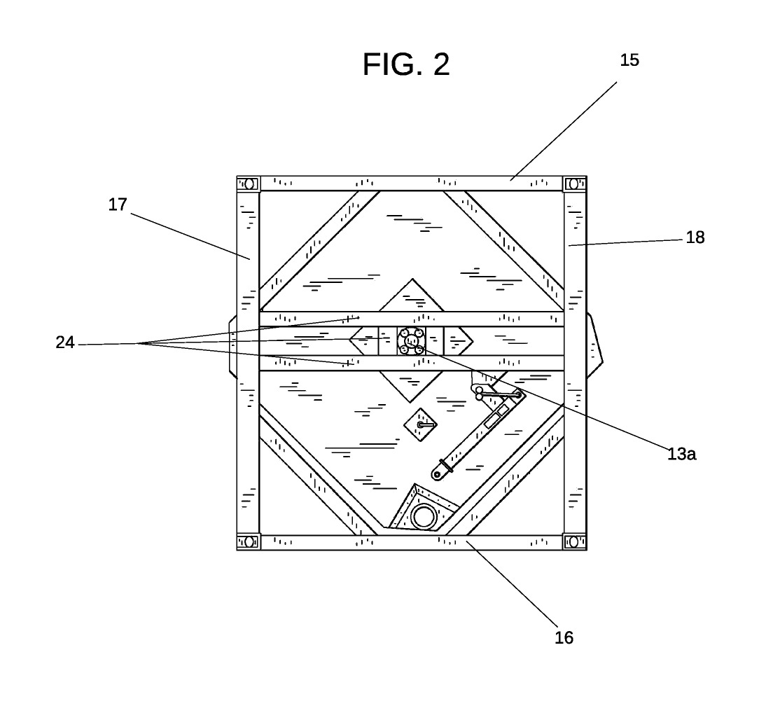

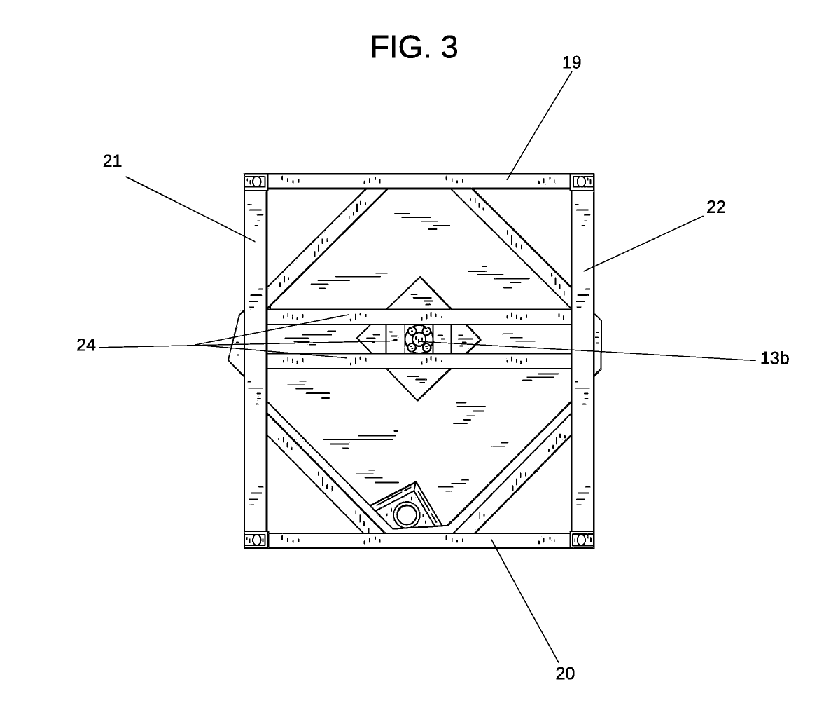

As illustrated in FIG. 9, an embodiment of a version of the invention comprises a rotator 13. In a preferred embodiment, the rotator 13 is a bearing system. It is understood that versions of the invention comprise any rotation mechanism. As illustrated in FIG. 2 and FIG. 3, an embodiment of a version of the invention comprises the bearing system has a front bearing 13a on the front side of the container and a back bearing 13b on the back side of the container.

Further shown in FIG. 9, an embodiment of a version of the invention comprises a structural rod 100 for attaching the rotator 13 to the exoskeleton 11. In one embodiment, the structural rod 100 has a front end 100a and back end 100b. The structural rod front end 100a is in contact with the front bearing 13a on the front side of the exoskeleton. The structural rod back 100b end is connected to the back bearing 13b on the back side of the exoskeleton.

As illustrated in FIG. 1, a preferred embodiment of a version of the invention is directed to a container 10 comprising an exoskeleton 11, a tank 12 positioned inside the exoskeleton, a rotator 13, and an offload system 14.

As illustrated in FIG. 2, in one embodiment, the container exoskeleton comprises a front end made up of an upper 15 and lower 16 support beam joined together by a left 17 and right 18 support beam. As illustrated in FIG. 3, a version of the invention further comprises an exoskeleton back end made up of upper 19 and lower 20 support beams joined together by left 21 and right 22 support beams. As noted in FIG. 1, the exoskeleton front end and back end are joined together in each corner by support beams 23a and 23b. As shown in FIG. 2 and FIG. 3, the exoskeleton 11 further comprises rotator support beams 24 to harness a front and back bearing system.

The shape of the exoskeleton set forth herein is only one embodiment of a version of the invention. The exoskeleton structure set forth herein is a preferred embodiment, and includes other configurations of supporting a tank and rotator. These other configurations include, but are not limited to, support beams located in different configurations or secured at different points.

As noted in FIG. 1, a preferred embodiment of a version of the invention further comprises a tank 12 positioned inside the exoskeleton 11. As illustrated in FIG. 8, in a preferred embodiment, the tank comprises a front end 30 and a back end 31. In one embodiment, the front end 30 and back end 31 are connected by an upper side 32 and a bottom side 33, a left side 34 and right side 35, and corner sides 36. The corner sides 36 of the tank 12 are cut to allow the tank to rotate inside the exoskeleton 11. In one version, the upper side 32 of the tank has a receiver 37 capable of receiving material into the tank. In a preferred embodiment, the lower side 33 of the tank has an offload system 14 capable of unloading material from the tank. In one embodiment, the tank 12 is connected to the exoskeleton 11 by a rotator 13.

In a preferred embodiment, the rotator 13 between the tank 12 and exoskeleton 13 comprises a front end and a back end. In one version of the invention, the front end of the rotator 13a is capable of rotating a structural rod 100. Preferably, the back end of the rotator 13b is capable of rotating the structural rod 100. In a preferred embodiment of a version of the invention the structural rod 100 runs the length of the tank. Preferably, the structural rod is connected to the tank and in contact with the front and back end rotator.

A version of the invention further comprises the tank is capable of unloading a material by a corner offload system 14 located in the bottom corner of the tank. In a preferred embodiment, the corner offload system runs the length of the tank. As illustrated in FIG. 1, in one embodiment, when unloading the tank, the tank is rotated so that the corner offload system is located nearest the ground, such that the tank is in a diamond shape. As illustrated in FIG. 8, in one embodiment, the tank is rotated when in transport mode such that the offload channel is located in the bottom corner and the tank does not extend outside the exoskeleton.

In a preferred embodiment of a version of the invention, the exoskeleton comprises a front and a back. The front and back each have a bottom support beam. As illustrated in FIG. 2, the bottom front support beam 16 is connected to a front upper support beam 15 by a front left 17 and front right 18 support beam. These front beams connected together form a front side of the exoskeleton. As illustrated in FIG. 3, the bottom back support beam 20 is connected to a back upper support beam 19 by a back left 21 and back right 22 support beam. These back beams connected together form a back side of the exoskeleton.

As illustrated in FIG. 1, the front and back side of the exoskeleton are connected by top 23a and bottom 23b corner support beams. The top corner support beams 23a connect the upper corners of the front and back sides of the exoskeleton. The bottom corner support beams 23b connect the lower corners of the front and back sides of the exoskeleton. As shown in FIG. 2 and FIG. 3, the front and back sides of the exoskeleton comprise rotator support beams 24 for securing a rotator in place.

In a preferred embodiment of a version of the invention, the rotator 13 comprises a front bearing on the front side 13a of the container and exoskeleton and a back bearing on the back side 13b of the container and exoskeleton.

As shown in FIG. 10, a preferred embodiment of a version of the invention comprises a container offload system 14 comprising a longitudinal body 50 in the shape of a diamond with an open bottom 51 for commodities to pass. In a preferred embodiment, the diamond shaped longitudinal body 50 has an open bottom 51 forming a channel therein. The commodities pass through the open bottom 51 into the channel. Preferably, the container offload system 14 has spacers 54 attached thereto. The spacers 54 are attached to exterior sides of the longitudinal body lower section 53 so as to be in contact with the commodity. In one embodiment, the spacers 54 are triangles.

Preferably, the triangle spacers 54 have a flat bottom and a pointed top. The flat bottom is located near the open space at the bottom 51 of the longitudinal section lower body 53. The top point is located farthest away from the open space at the bottom 51 of the longitudinal section lower body 53. In a preferred embodiment, the spacers 54 are staggered on each side of the longitudinal body lower section 53 such that the middle of the bottom section of a spacer 54 on one side of the longitudinal section lower body 53 is opposite the space between two spacers 54 on the opposite side of the longitudinal section lower body 53.

An embodiment of a version of the invention further comprises the container is used for transport, onsite storage, shipping, and/or intermodal shipping.

It is understood that versions of the invention may be comprised of various materials. In a preferred embodiment, the container and elements making up the container are comprised of metal. In yet another embodiment, the container and elements making up the container are comprised of polymer. It is understood that versions of the invention may be made of various materials, both natural and synthetic.

An embodiment of a version of the invention further comprises the method of shipping and unloading the container as set forth above. As illustrated in FIG. 8, a preferred method comprises the container is left in a traveling position during shipping and transport. The tank being fully inside the exoskeleton with no sections protruding from the exoskeleton defines the traveling position. As illustrated in FIG. 1, a preferred method further comprises rotating the container to an unloading position for commodity offload. The offload position is defined by the tank being slightly rotated such that a corner offload system located in the bottom corner of the tank is positioned at the bottom location nearest the ground. In one embodiment, while in the unloading position, the tank forms a diamond shape. In a preferred embodiment, commodities are unloaded from the container by the offload system.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this inventive subject matter can be made without departing from the principles and scope of the inventive subject matter as expressed in the subjoined claims.

What is claimed is:

1. A container system comprising:
a) an exoskeleton,
b) a rotator connected to the exoskeleton, and
c) a structural rod connected to the rotator and exoskeleton.

2. A container as in claim 1, further comprising a tank positioned inside the exoskeleton.

3. A container as in claim 2, the container being a shipping container.

4. The container of claim 2, the container being for onsite storage.

5. A container as in claim 2, the container being an intermodal container.

6. A container as in claim 2, further comprising:
a) the tank inside the exoskeleton having an upper and lower portion,
b) the upper portion of the tank receiving material into the tank,
c) the lower portion of the tank capable of unloading material from the tank.

7. A container as in claim 2, further comprising:
a) the container having a front and back side,
b) the rotator between the tank and exoskeleton being a bearing system,
c) the bearing system having at least one front bearing on the front side of the container and at least one back bearing on the back side of the container.

8. A container as in claim 7, further comprising:
a) a structural rod connecting the tank to the rotator and exoskeleton,
b) the structural rod having a front and back end,
c) the structural rod front end being in contact with the front bearing on the front side of the container and exoskeleton, and
d) the structural rod back end being in contact with the back bearing on the back side of the container and exoskeleton.

9. A container comprising:
a) an exoskeleton, further comprising:
i. a front end made up of an upper and lower support beam joined together by a left and right support beam,
ii. a back end made up of an upper and lower support beam joined together by a left and right support beam,
iii. the front end and back end being joined together by support beams connected at a corner of each front and back end,
iv. the exoskeleton further comprising support beams to harness a front and back bearing system,
b) a tank positioned inside the exoskeleton, the tank comprising:
i. a front end and a back end,
ii. the front end and back end being connected by a top side and a bottom side, a left side and right side, and corner sides,
iii. the corner sides of the tank being cut to allow the tank to rotate inside the exoskeleton,
iv. the top side of the tank being capable of receiving material into the tank,
v. the bottom side being capable of unloading material from the tank,
vi. the tank being connected to the exoskeleton by a rotator,
c) a rotator between the tank and exoskeleton, the rotator comprising:
i. a front end and a back end,
ii. the front end being capable of rotating a structural rod,
iii. the back end being capable of rotating the structural rod,
iv. the structural rod running the length of the tank,
v. the structural rod being connected to the tank and in contact with the front and back end rotator.

10. A container as in 9, further comprising, material is offloaded from the tank by a corner offload system located in the bottom corner of the tank,
a) the corner offload system running the length of the tank,
b) the tank being rotated so that the corner offload system is located nearest the ground.

11. A container comprising:
a) an exoskeleton, the exoskeleton comprising:
i. a front and a back,
ii. the front and back each having a bottom support beam,
iii. the bottom front support beam being connected to a front upper support beam by a front left and front right support beam,
iv. the front beams connected together forming a front side of the exoskeleton,
v. the bottom back support beam being connected to a back upper support beam by a back left and back right support beam,
vi. the back beams connected together forming a back side of the exoskeleton,
vii. the front and back side of the exoskeleton being connected by top and bottom support beams,
viii. the top support beams connecting the upper corners of the front and back upper support beams,
ix. the bottom support beams connecting the lower corners of the front and back lower support beams,
x. the front and back side of the exoskeleton comprising support beams for securing a rotator in place,
b) a tank comprising:
i. a front end and a back end,
ii. the front end and back end being connected by a top side and a bottom side, a left side and right side, and corner sides,
iii. the corner sides of the tank being cut to allow the tank to rotate inside the exoskeleton,
iv. the top side of the tank allowing for loading material into the tank,
v. the bottom side allowing for unloading material from the tank,
vi. the tank being connected to the exoskeleton by a rotator,
c) a rotator, comprising a front bearing on the front side of the container and exoskeleton and a back bearing on the back side of the container and exoskeleton, and
d) an offload system comprising,
i. a longitudinal body with an open bottom for commodities to pass,
ii. the longitudinal body forming a channel therein,
iii. commodities passing through the open bottom into the channel,
iv. the longitudinal body having an upper and lower section,
v. the upper section forming the upper portion of the longitudinal body,
vi. the lower section of the longitudinal body not being joined together and having a separation for commodities to pass,
vii. the lower section of the longitudinal body having spacers attached thereto,
viii. the spacers being attached to both sides of the lower section of the longitudinal body,
ix. the spacers being attached to the longitudinal body lower section so as to be in contact with the commodity.

12. The container of claim 11, further comprising:
a) the spacers being triangles having a flat bottom and a pointed top,
b) the flat bottom being located near the open space at the bottom of the longitudinal section lower body, and
c) the top point being located farthest away from the open space at the bottom of the longitudinal section lower body,
d) the spacers being staggered on each side of the longitudinal body lower section such that the middle of the bottom section of a spacer on one side of the longitudinal section lower body is opposite the space between two spacers on the opposite side of the longitudinal section lower body.

13. The container of claim 11, further comprising, the container being for onsite storage.

14. The container of claim 11, further comprising, the container being for shipping.

15. The container of claim 11, further comprising, the container being an intermodal container.

16. The container of claim 12, further comprising, the container being for onsite storage.

17. The container of claim 12, further comprising, the container being for shipping.

18. The container of claim 12, further comprising, the container being an intermodal container.

19. The method of shipping and unloading the container of claim 9, the method comprising:
a) the container being left in a traveling position during shipping and transport,
b) the traveling position being defined by the tank being fully inside the exoskeleton,
c) the container being rotated to offloading position during offload,
d) the offload position being defined by the tank being slightly rotated such that a corner offload system located in the bottom corner of the tank is positioned at the bottom location nearest the ground, and
e) while in the offloading position, the tank is offloaded.
